(19) United States
(12) Patent Application Publication
(10) Pub. No.: US 2017/0120197 A1
(43) Pub. Date: May 4, 2017

(54) INTERMITTENT-BUBBLING DEVICE

(71) Applicant: SUMITOMO ELECTRIC INDUSTRIES, LTD., Osaka-shi, Osaka (JP)

(72) Inventors: Hiromu TANAKA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 15/119,774

(22) PCT Filed: Mar. 16, 2015
(86) PCT No.: PCT/JP2015/057761

§ 371 Date: Aug. 18, 2016

(30) Foreign Application Priority Data
Mar. 25, 2014 (JP) 2014-062807

(51) Int. Cl. B01D 65/02

(52) U.S. Cl. CPC B01D 65/02; B01D 2321/185

(57) ABSTRACT

An object is to provide an intermittent-bubbling device that can generate a bubble having a large diameter and that can be suitably used for, for example, claiming a filtration module. The present invention provides an intermittent-bubbling device used while being immersed in a liquid, and formed from a series of tubes, the intermittent-bubbling device including a gas storage path, one end of which opens downward, which stores a predetermined amount of gas, and which has a substantially inverted U-shape, and a gas-guiding path that communicates with the other end of the gas storage path, and that guides the gas upward from the other end. Preferably, a highest point at a lowest position of the gas-guiding path is not lower than the other end of the gas storage path. A cross-sectional area on the one end side of the gas storage path at a horizontal level position horizontal to the other end of the gas storage path is preferably larger than a cross-sectional area of the gas-guiding path. An upper end of the gas-guiding path is preferably located at a level equal to or higher than a highest point of the gas storage path. The tubes that form the gas storage path or the gas-guiding path may be connected to one another so as to be rotatable about an axis.

### TECHNICAL FIELD

The present invention relates to an intermittent-bubbling device.

### BACKGROUND ART

A known technique for wastewater treatment is a method using a membrane module that separates impurities from water. In the method using such a membrane module, separation membranes of the membrane module need to be cleaned, because impurities are accumulated on the separation membranes. The separation membranes are cleaned, for example, using bubbles. An example of the technique using bubbles is a membrane module system that uses a pulsed gas lift pump (refer to Japanese Patent No. 4833353).

The membrane module system disclosed in this patent document is immersed in a liquid during use. The membrane module system supplies, to a membrane module, a high-speed gas-liquid two-phase flow of feed liquid and bubbles generated by continuous supply of pressurized gas, thereby scouring the surfaces of permeable hollow fiber membrane bundles in the membrane module. The high-speed gas-liquid two-phase flow contains a high-speed moving liquid and a large number of independent small-diameter bubbles in the liquid.

### CITATION LIST

### Patent Literature

PTL 1: Japanese Patent No. 4833353

### SUMMARY OF INVENTION

### Technical Problem

The capability to scour the membrane module (permeable hollow fiber membrane bundles) with bubbles largely depends on the energy of bubbles, particularly on the kinetic energy of bubbles and the degree of contact with the hollow fiber membranes. Therefore, with the method of supplying small-diameter bubbles to the permeable hollow fiber membrane bundles, the permeable hollow fiber membrane bundles cannot be sufficiently scrubbed with the bubbles and effective cleaning cannot be achieved. Accordingly, for effective cleaning, it is required to provide a device capable of generating large-diameter bubbles.

The present invention has been made in view of the circumstances described above. An object of the present invention is to provide an intermittent-bubbling device that is capable of generating large-diameter (large-volume) bubbles and can be suitably used for, for example, cleaning a membrane module.

### Solution to Problem

The invention made to solve the problems described above provides an intermittent-bubbling device used while being immersed in a liquid, and formed from a series of tubes, the intermittent-bubbling device including a gas storage path, one end of which opens downward, which stores a predetermined amount of gas, and which has a substantially inverted U-shape, and a gas-guiding path that communicates with the other end of the gas storage path, and that guides the gas upward from the other end.

### Advantageous Effects of Invention

The intermittent-bubbling device according to the present invention is capable of generating large-diameter (large-volume) bubbles and can be suitably used for, for example, cleaning a membrane module.

### BRIEF DESCRIPTION OF DRAWINGS

FIG. 1 is a schematic front view illustrating an intermittent-bubbling device according to a first embodiment of the present invention.

FIG. 2 is a schematic cross-sectional view for describing an operation of the intermittent-bubbling device illustrated in FIG. 1.

FIG. 3 is a schematic cross-sectional view for describing an operation of the intermittent-bubbling device illustrated in FIG. 1.

FIG. 4 is a schematic cross-sectional view for describing an operation of the intermittent-bubbling device illustrated in FIG. 1.

FIG. 5 is a schematic cross-sectional view for describing an operation of the intermittent-bubbling device illustrated in FIG. 1.

FIG. 6 is a schematic view for describing how the intermittent-bubbling device illustrated in FIG. 1 is used.

FIG. 7 is a schematic front view illustrating an intermittent-bubbling device according to a second embodiment of the present invention.

FIG. 8 is a schematic cross-sectional view of the intermittent-bubbling device illustrated in FIG. 7.

FIG. 9 is a schematic exploded perspective view of the intermittent-bubbling device illustrated in FIG. 7.

FIG. 10 is a schematic front view illustrating an intermittent-bubbling device according to a third embodiment of the present invention.

FIG. 11 is a schematic front view illustrating an intermittent-bubbling device according to a fourth embodiment of the present invention.

FIG. 12 is a schematic front view illustrating an intermittent-bubbling device according to a fifth embodiment of the present invention.

FIG. 13 is a schematic perspective view illustrating an intermittent-bubbling device according to a sixth embodiment of the present invention.

FIG. 14 is a schematic plan view illustrating of the intermittent-bubbling device illustrated in FIG. 13.

FIG. 15 is a cross-sectional view taken along line A-A of the intermittent-bubbling device illustrated in FIG. 14.

FIG. 16 is a cross-sectional view taken along line B-B of the intermittent-bubbling device illustrated in FIG. 14.

FIG. 17 is a schematic view for describing how the intermittent-bubbling device illustrated in FIG. 13 is used.

FIG. 18 is a schematic perspective view illustrating an intermittent-bubbling device according to a seventh embodiment of the present invention.

FIG. 19 is a schematic plan view of the intermittent-bubbling device illustrated in FIG. 18.

FIG. 20 is a cross-sectional view taken along line C-C of the intermittent-bubbling device illustrated in FIG. 19.

FIG. 21 is a schematic front view illustrating an intermittent-bubbling device according to another embodiment of the present invention.

FIG. 22 is a schematic plan view illustrating the intermittent-bubbling device illustrated in FIG. 21.

### DESCRIPTION OF EMBODIMENTS

### [Description of Embodiments of the Present Invention]

The present invention provides an intermittent-bubbling device used while being immersed in a liquid, and formed from a series of tubes, the intermittent-bubbling device including a gas storage path, one end of which opens downward, which stores a predetermined amount of gas, and which has a substantially inverted U-shape, and a gas-guiding path that communicates with the other end of the gas storage path, and that guides the gas upward from the other end.

The intermittent-bubbling device includes the gas storage path having a substantially inverted U-shape. Accordingly, the gas introduced into the gas storage path is first stored in the vicinity of the top of the gas storage path. Subsequently, when the gas is further introduced, a certain amount or more of the gas is stored in the gas storage path, and thereafter, the interface between the gas and the liquid is branched into one end side (opening side) of the gas storage path and the other end side (gas-guiding path side). When the gas is further introduced into the gas storage path, an interface on the one end side of the gas storage path (rear-end interface) moves toward the one end side (opening side) of the gas storage path whereas an interface on the other end side of the gas storage path (front-end interface) of the gas storage path moves to the gas-guiding path side. At this time, since a liquid pressure acts on the front-end interface and the rear-end interface, these interfaces move while maintaining substantially the same horizontal level position. Subsequently, when the amount of the gas in the gas storage path exceeds a predetermined amount, the gas in the gas storage path is guided upward through the gas-guiding path, and a relatively large bubble is intermittently released. The reason why a large bubble is released is not clear, but possible reasons are, for example, as follows. When the gas stored in the gas storage path is released from the gas-guiding path, the gas is collected by the surface tension thereof. When the gas is released from the gas-guiding path, a suction force acts on the subsequent gas. A liquid pressure in the upward direction acts on the rear-end interface of the gas storage path.

Preferably, a highest point at a lowest position of the gas-guiding path is not lower than the other end of the gas storage path. In this manner, when the highest point at the lowest position of the gas-guiding path is not lower than the other end of the gas storage path, the gas stored in the gas storage path is easily released through the gas-guiding path, and an increase in the diameter of a bubble can be promoted.

A cross-sectional area on the one end side of the gas storage path at a horizontal level position horizontal to the other end of the gas storage path is preferably larger than a cross-sectional area of the gas-guiding path. In this manner, when the cross-sectional area on the one end side of the gas storage path at a horizontal level position horizontal to the other end of the gas storage path is larger than the cross-sectional area of the gas-guiding path, a liquid pressure acting on the rear-end interface of the gas present in the gas storage path can be made higher than that acting on the front-end interface. Consequently, the gas in the gas storage path can be discharged more effectively and at one time, and a large bubble can be generated more effectively.

An upper end of the gas-guiding path is preferably located at a level equal to or higher than a highest point of the gas storage path. In this manner, when the upper end of the gas-guiding path is located at a level equal to or higher than the highest point of the gas storage path, it is possible to ensure a large difference in position in the vertical direction between the other end of the gas storage path and the upper end of the gas-guiding path (distance of the movement of gas in the gas-guiding path in the vertical direction). Therefore, when the gas in the gas-guiding path moves, the gas does not easily disperse but rather easily gathers due to surface tension. As a result, the gas in the gas storage path can be discharged through the gas-guiding path more effectively and at one time, and a large bubble can be generated more effectively.

The tubes that form the gas storage path or the gas-guiding path are preferably connected to one another so as to be rotatable about an axis. In this manner, when the tubes that form the gas storage path or the gas-guiding path are connected to one another so as to be rotatable about an axis, the intermittent-bubbling device can be flexibly used for various filtration modules etc. having different shapes, arrangements, and the like of a part to which a gas is supplied.

The one end side of the gas storage path is preferably formed from a rectangular parallelepiped box body, and the other end side of the gas storage path is preferably formed from a pipe communicating with the box body. In this manner, when the gas storage path is formed from a box body and a pipe, the cross-sectional area on the one end side of the gas storage path can be simply and easily made larger than the cross-sectional area on the other end side. As a result, the liquid pressure acting on the rear-end interface of the gas in the gas storage path can be simply and reliably increased. Thus, the gas in the gas storage path can be discharged more effectively and at one time, and a large bubble can be generated more effectively.

The gas storage path and the gas-guiding path are preferably formed by dividing a single box body into sections and allowing the sections to communicate with each other. In this manner, when the gas storage path and the gas-guiding path are formed by dividing a single box body into sections and allowing the sections to communicate with each other, the gas storage path and the gas-guiding path can be easily formed. According to this structure, for example, a plurality of the intermittent-bubbling devices can be easily arranged in series by allowing sidewalls to face each other. Furthermore, a plurality of bubbles can be released at a high density.

The other end side of the gas storage path is preferably divided into a plurality of sections. In this manner, when the other end side of the gas storage path is divided into a plurality of sections, the gas in the gas storage path can be efficiently guided to the gas-guiding path to increase a releasing efficiency of bubbles.

The intermittent-bubbling device is preferably used for cleaning a filtration module including a filtration membrane. When the intermittent-bubbling device is used for cleaning a filtration module, bubbles having a large diameter can be supplied from the intermittent-bubbling device to the filtration module. These bubbles having a large diameter have large buoyancy and can efficiently scrub or shake the filtration membrane of the filtration module. Consequently, the intermittent-bubbling device can clean the filtration module effectively.

Herein, the “series of tubes” is not limited to a tube formed from a single tube, but may be a tube obtained by connecting a plurality of tubular members in series. The term “series of tubes” also covers a tube in which a path of gas is branched as long as the path is formed by a single tube or a plurality of tubular members. The cross-sectional shape of the “tube” is not limited to a circle. Examples of the cross-sectional shape of the “tube” further include rectangles such as a long rectangle, and other shapes. The term “tubular member” also covers a member formed by providing a partition such as a partition wall in a box body. The term “path” in the gas storage path and the gas-guiding path refers to a space defined by an inner surface of a tube. The term “substantially U-shape” refers to a structure in which both end sides that are continuous to a central portion (top) extend downward.

### [Details of Embodiments of the Present Invention]

Intermittent-bubbling devices according to the present invention will now be described as a first embodiment to a seventh embodiment with reference to the drawings.

### First Embodiment

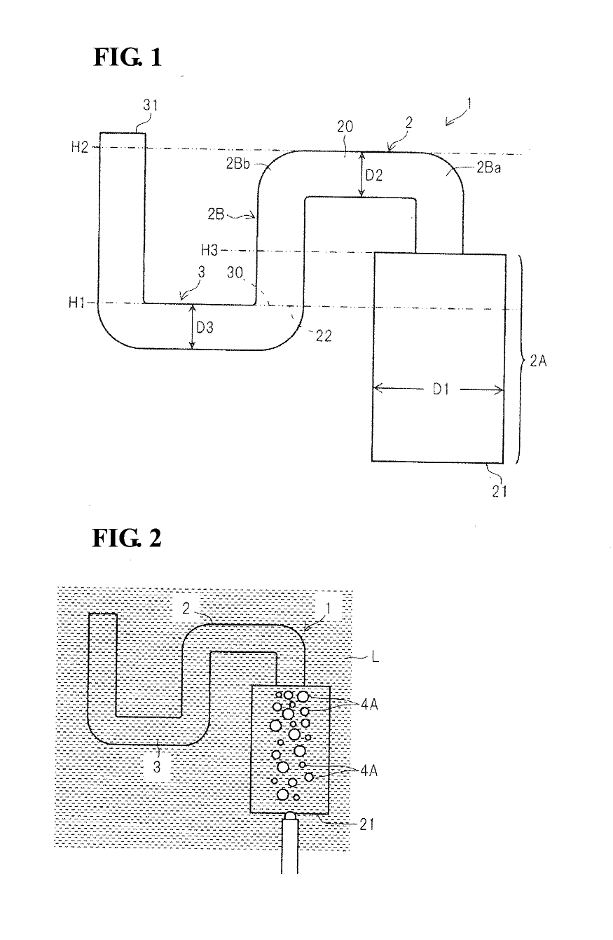

First, an intermittent-bubbling device according to a first embodiment of the present invention will be described with reference to FIGS. 1 to 5.

An intermittent-bubbling device 1 in FIG. 1 is used while being immersed in a liquid, and is used for, for example, cleaning a filtration module including filtration membranes. The intermittent-bubbling device 1 is formed from a series of tubes. The intermittent-bubbling device 1 includes a gas storage path 2 and a gas-guiding path 3. The gas storage path 2 and the gas-guiding path 3 are defined by the inner surface of the series of tubes.

### <Gas Storage Path 2>

The gas storage path 2 stores a predetermined amount of introduced gas. The gas storage path 2 has a substantially inverted U-shape in which one end 21 side and the other end 22 side that are continuous to a central portion (near the top) 20 extend downward in the vertical direction.

The one end 21 side of the gas storage path 2 is formed from a tube 2A having a diameter larger than that of the central portion 20 and the other end 22 side. This large-diameter tube 2A has a uniform inner diameter D1. The inner diameter D1 of the large-diameter tube 2A is the same as the outer diameter on the one end 21 side of the gas storage path 2.

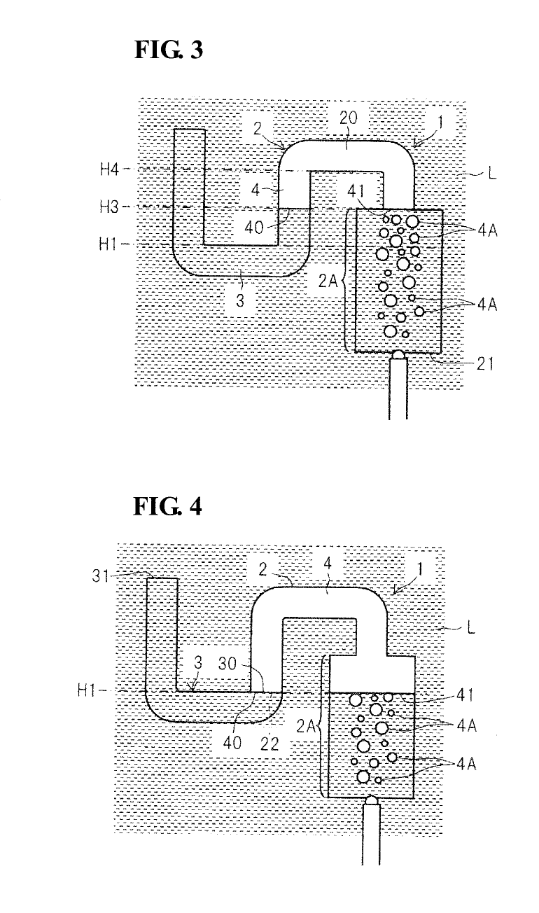

The one end 21 of the large-diameter tube 2A (the one end of the gas storage path 2) is located lower than the other end 22 of the gas storage path 2 and opens downward to form an inlet port (hereinafter may be referred to as “inlet port 21”). This inlet port 21 functions as a portion from which a gas 4 to be stored in the gas storage path 2 is introduced and also functions as a portion from which a liquid L to be introduced into the gas storage path 2 is suctioned when a bubble 4B is generated (refer to FIGS. 3 to 5).

The other end 22 side and the central portion 20 of the gas storage path 2 are formed from a small-diameter tube 2B. Except for curved portions 2Ba and 2Bb, the whole of the small-diameter tube 2B has a uniform inner diameter. The other end 22 of the small-diameter tube 2B (the other end of the gas storage path 2) communicates with the gas-guiding path 3. Herein, the other end 22 of the gas storage path 2 refers to a lowest point at which the gas in the gas storage path 2 on the gas-guiding path 3 side can be present, that is, a horizontal level H1 position in FIGS. 1 and 4. The inner diameter D2 of the small-diameter tube 2B is the same as the outer diameter of the other end 22 side and the central portion 20 of the gas storage path 2.

### <Gas-Guiding Path>

The gas-guiding path 3 guides the gas in the gas storage path 2 upward, and one end 30 communicates with the other end 22 of the gas storage path 2. The gas-guiding path 3 has a substantially L-shape, the whole of which has a uniform inner diameter. Preferably, a highest point at a lowest position of the gas-guiding path 3 is not lower than the other end 22 of the gas storage path 2. FIG. 1 illustrates a case where the highest point at the lowest position of the gas-guiding path 3 is located at the same position as the other end 22 of the gas storage path 2 at the horizontal level position H1. In this manner, when the highest point at the lowest position of the gas-guiding path 3 is not lower than the other end 22 of the gas storage path 2, the gas stored in the gas storage path 2 is easily released through the gas-guiding path 3, and an increase in the diameter of a bubble can be promoted.

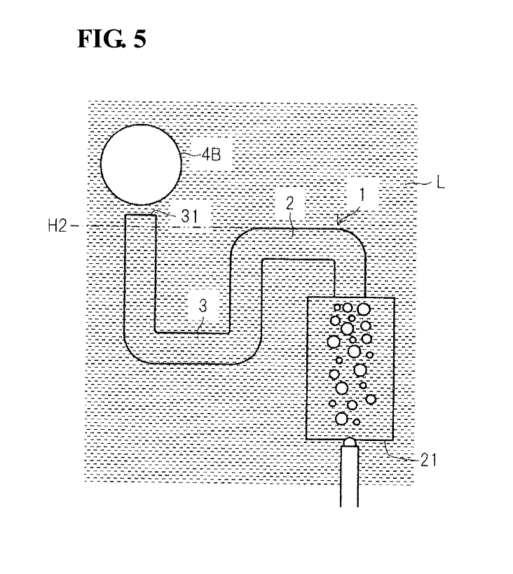

The outer diameter D3 of the gas-guiding path 3 is the same or substantially the same as the outer diameter D2 of the other end 22 side and the central portion 20 of the gas storage path 2 (the inner diameter of the small-diameter tube 2B), and a preferred range of the inner diameter D3 is also the same. Specifically, the inner diameter D3 of the gas-guiding path 3 is smaller than the inner diameter D1 of the one end 21 side (the large-diameter tube 2A) of the gas storage path 2. In addition, a cross-sectional area on the one end 21 side of the gas storage path 2 at the horizontal level position H1 horizontal to the other end 22 of the gas storage path 2 is larger than a cross-sectional area of the gas-guiding path 3. In this manner, when the cross-sectional area on the one end 21 side of the gas storage path 2 at the horizontal level position H1 horizontal to the other end 22 of the gas storage path 2 is larger than the cross-sectional area of the gas-guiding path 3, a liquid pressure acting on a rear-end interface 41 can be made higher than that acting on a front-end interface 40 of the gas 4 present in the gas storage path 3 (refer to FIG. 4). Consequently, the gas 4 in the gas storage path 2 can be discharged more effectively and at one time, and a large bubble 4B can be generated more effectively (refer to FIGS. 4 and 5).

The other end 31 of the gas-guiding path 3 forms a gas discharge port (hereinafter may be referred to as “gas discharge port 31”). This gas discharge port 31 functions as a portion from which the gas 4 stored in the gas storage path 2 is discharged as a bubble 4B to the outside (refer to FIGS. 3 to 5). The gas discharge port 31 is located higher than a horizontal level position 112, which is a highest point of the gas storage path 2. When the gas discharge port 31 is located higher than the horizontal level position H2, which is the highest point of the gas storage path 2, it is possible to ensure a large difference in position in the vertical direction between the other end 22 of the gas storage path 2 and the other end 31 of the gas-guiding path 3 (distance of the movement of gas in the gas-guiding path 3 in the vertical direction). Therefore, when the gas in the gas-guiding path 3 moves, the gas does not easily disperse but rather easily gathers due to surface tension. As a result, the gas 4 in the gas storage path 2 can be discharged through the gas-guiding path 3 more effectively and at one time, and a large bubble 4B can be generated more effectively (refer to FIGS. 3 to 5).

The inner diameter of the gas discharge port 31 is smaller than the inner diameter of the inlet port 21. That is, the area of the gas discharge port 31 is smaller than the area of the inlet port 21. It is believed that the liquid pressure acting on the front-end interface 40 of the gas 4 in the gas storage path 2 depends on the size of the outer diameter (cross-sectional area) of the gas discharge port 31. It is also believed that the liquid pressure acting on the rear-end interface 41 of the gas 4 in the gas storage path 2 depends on the size of the outer diameter (cross-sectional area) of the inlet port 21. Therefore, in the intermittent-bubbling device 1, when the rear-end interface 41 is present in the large-diameter tube 2A, the liquid pressure acting on the rear-end interface 41 of the gas 4 present in the gas storage path 2 is believed to be larger than the liquid pressure acting on the front-end interface 40 of the gas 4. The inner diameter of the gas discharge port 31 is the same or substantially the same as the average inner diameter D2 of the small-diameter tube 2B.

### <Operation of Intermittent-Bubbling Device>

An operation of the intermittent-bubbling device 1 will now be described with reference to FIGS. 2 to 5. Note that the bubble-generating mechanism illustrated in FIGS. 2 to 5 is merely an exemplary and schematic representation. The bubble-generating mechanism may be changed depending on the shapes, dimensions, positional relationship, etc. of the gas storage path 2 and the gas-guiding path 3, and hence the following description does not necessarily accurately reflect an actual bubble-generating mechanism. In the description below, a case where all gas 4 in the gas storage path 2 is discharged at one time will be described as an example.

As illustrated in FIGS. 2 to 5, the intermittent-bubbling device 1 is used to generate a bubble 4B while being immersed in a liquid L. FIG. 2 illustrates a state at the time of initial use or a state immediately after the bubble 4B is generated (refer to FIG. 5), in which the gas storage path 2 and the gas-guiding path 3 are filled with the liquid L.

As illustrated in FIG. 2, when the bubble 4B (refer to FIG. 5) is generated, the gas 4A is introduced into the gas storage path 2 through the inlet port 21. The gas 4A is supplied as a plurality of independent bubbles using a gas supply source (not shown). In this case, since the average inner diameter D1 on the one end 21 side of the gas storage 2 is larger than the average inner diameter D2 of the central portion 20 and on the other end 22 side of the gas storage path 2 (refer to FIG. 1), the gas 4A can be reliably introduced into the gas storage path 2. The amount of the gas 4A introduced into the gas storage path 2 may be determined in accordance with the forms and the diameters of the gas storage path 2 and the gas-guiding path 3.

As illustrated in FIG. 3, when the gas 4A is continuously supplied to the gas storage path 2, first, a gas 4 is stored in the central portion 20 of the gas storage path 2, and an interface between the gas 4 and the liquid L moves downward. When the interface reaches a horizontal level position H4 and thereafter, the front-end interface 40 of the gas 4 moves downward on the other end 22 side of the gas storage path 2 whereas the rear-end interface 41 of the gas 4 move downward toward the one end (inlet port) 21 side of the gas storage path 2. At this time, the front-end interface 40 and the rear-end interface 41 move downward while maintaining the horizontal level. However, when the front-end interface 40 and the rear-end interface 41 reach a horizontal level position H3 and thereafter, the rear-end interface 41 moves in the large-diameter tube 2A.

As illustrated in FIG. 4, when the front-end interface 40 reaches the horizontal level position H1 (the other end 22 of the gas storage path 2 and the one end 30 of the gas-guiding path 3), the liquid seal is broken at this horizontal level position H1. As a result, as illustrated in FIGS. 4 and 5, the gas 4 in the gas storage path 2 is discharged to the outside through the gas discharge port 31. In this case, at the horizontal level position H1, since the outer diameter (cross-sectional area) of the other end 22 of the gas storage path 2 in which the front-end interface 40 is located is smaller than the outer diameter of the gas storage path 2 in which the rear-end interface 41 is located, the liquid pressure acting on the rear-end interface 41 of the gas 4 is higher than the liquid pressure acting on the front-end interface 40 of the gas 4. Accordingly, since the liquid pressure acting on the rear-end interface 41 of the gas 4 becomes higher than the liquid pressure acting on the front-end interface 40, the bubble 4B having a relatively large diameter is discharged to the outside without changing the gas 4 in the gas-guiding path 3 to small bubbles.

Furthermore, due to the operation of the difference in density between the gas 4 and the liquid L (buoyancy of the gas 4), the surface tension of the gas 4, and the like, the large-diameter bubble 4B can be discharged through the gas-guiding path 3 at one time without reducing the diameter of the gas 4 in the gas storage path 2. It is believed that, in particular, since the gas discharge port 31 is located higher than the horizontal level position H2, which is the highest point of the gas storage path 2, the gas 4 in the gas storage path 2 can be discharged through the gas-guiding path 3 more effectively at one time as described above, and the large-diameter bubble 4B can be generated more effectively.

As a result of the movement of the gas 4 from the gas storage path 2 to the gas-guiding path 3, a suction force acts on the one end 21 side of the gas storage path 2. Accordingly, the liquid L is suctioned in the gas storage path 2 through the inlet port 21, and the gas storage path 2 is filled with the liquid L, as illustrated in FIGS. 2 and 5.

The generation of the bubble 4B described above can be intermittently and repeatedly performed by continuously supplying the gas 4A.

### <How Intermittent-Bubbling Device is Used>

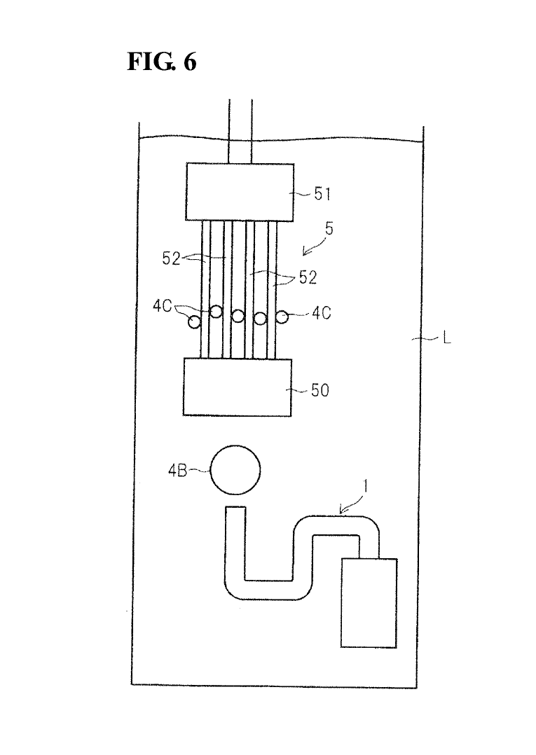

As illustrated in FIG. 6, for example, the intermittent-bubbling device 1 is disposed below a filtration module 5 immersed in a liquid L. The intermittent-bubbling device 1 is used for cleaning the filtration module 5 by supplying bubbles to the filtration module 5. The filtration module 5 includes a pair of securing members 50 and 51 configured to secure a plurality of filtration membranes 52.

When the intermittent-bubbling device 1 supplies a bubble 4B from the filtration module 5, the bubble 4B is divided by the securing member 50 into a plurality of smaller bubbles 4C, which move upward while being in contact with the surfaces of the plurality of filtration membranes 52. The smaller bubbles 4C have an average diameter close to the distance between the filtration membranes 52 and are easily distributed evenly among the filtration membranes 52. Accordingly, the surfaces of the filtration membranes 52 can be thoroughly cleaned with the smaller bubbles 4C. Since the smaller bubbles 4C move up faster than conventional microbubbles, the surfaces of the filtration membranes 52 can be effectively cleaned with high scrubbing pressure. When the filtration membranes 52 are vertically disposed as in the filtration module 5 illustrated, the smaller bubbles 4C move upward in the longitudinal direction of the filtration membranes 52. This allows more efficient and effective cleaning of the surfaces of the filtration membranes 52.

### <Advantages>

The intermittent-bubbling device 1 includes the gas storage path 2 having a substantially inverted U-shape. Accordingly, the gas 4A introduced from the one end (inlet port) 21 of the gas storage path 2 is first stored in the central portion 20 of the gas storage path 3. Subsequently, when the gas 4A is further introduced, a certain amount or more of the gas 4 is stored in the gas storage path 2, and thereafter, the interface between the gas 4 and the liquid L is branched into the one end (inlet port) 21 side of the gas storage path 2 and the other end 22 (gas-guiding path 3) side. When the gas 4A is further introduced from the one end (inlet port) 21 side of the gas storage path 2, the rear-end interface 41 of the gas storage path 2 moves toward the one end (inlet port) 21 of the gas storage path 2 whereas the front-end interface 41 of the gas storage path 2 moves to the gas-guiding path 3 side. At this time, since a liquid pressure acts on to the front-end interface 40 and the rear-end interface 41, these interfaces 40 and 41 move while maintaining substantially the same horizontal level position. Subsequently, when the amount of the gas 4 in the gas storage path 2 exceeds a predetermined amount, the gas 4 in the gas storage path 2 is guided upward through the gas-guiding path 3, and a relatively large bubble 4B is intermittently released. The reason why the large bubble 4B is released is not clear, but possible reasons are, for example, as follows. When the gas 4 stored in the gas storage path 2 is released from the gas-guiding path 3, the gas 4 is collected by the surface tension thereof. When the gas 4 is released from the gas-guiding path 3, a suction force acts on the subsequent gas 4. A liquid pressure in the upward direction acts on the rear-end interface 41 of the gas storage path 2.

### Second Embodiment

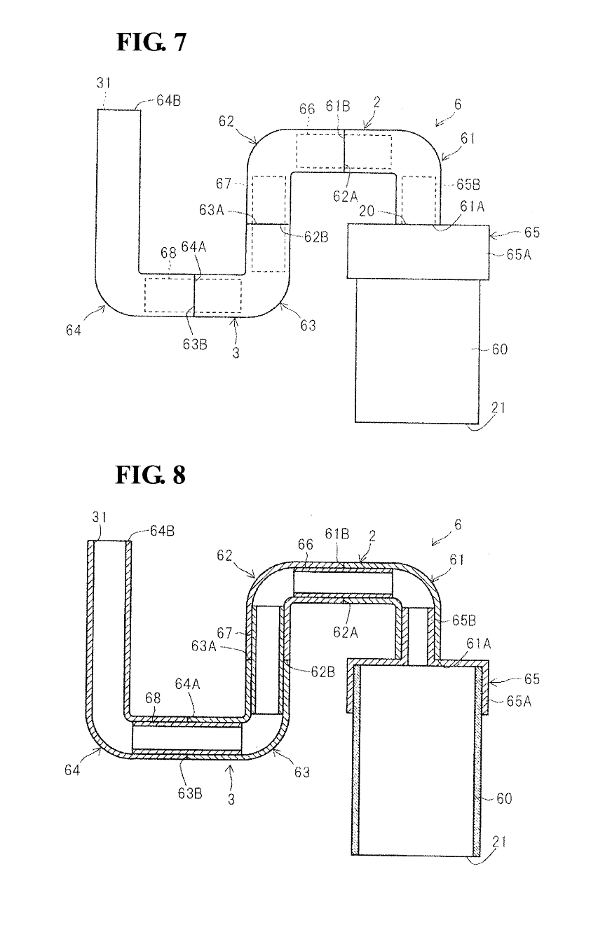

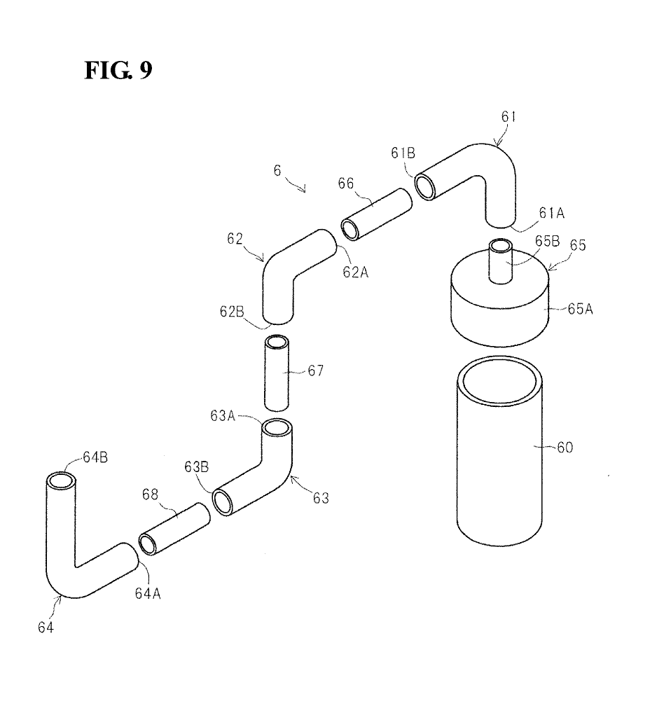

Next, an intermittent-bubbling device according to a second embodiment of the present invention will be described with reference to FIGS. 7 to 9. In FIGS. 7 to 9, structures the same as those of the intermittent-bubbling device 1 in FIG. 1 are assigned the same reference numerals, and an overlapping description is omitted below.

An intermittent-bubbling device 6 has an overall structure similar to the intermittent-bubbling device 1 in FIG. 1 and includes a gas storage path 2 and a gas-guiding path 3. The intermittent-bubbling device 6 is formed as a series of tubes by connecting a plurality of pipe materials to one another.

The intermittent-bubbling device 6 is formed as a series of tubes by connecting a cylindrical body 60, a first L-shaped pipe 61, a second L-shaped pipe 62, a third L-shaped pipe 63, and a fourth L-shaped pipe 64 through a joint cap 65, a first joint pipe 66, a second joint pipe 67, and a third joint pipe 68.

The inner diameter of the cylindrical body 60 corresponds to the outer diameter D1 on the one end 21 side of the gas storage path 2 in the intermittent-bubbling device 1 in FIG. 1. The inner diameter of each of the first to fourth L-shaped pipes 61 to 64 corresponds to the outer diameter D2 on the other end 22 side of the gas storage path 2 and the inner diameter D3 of the gas-guiding path 3 in the intermittent-bubbling device 1 in FIG. 1. Therefore, a preferred range of the inner diameter of each of the first to fourth L-shaped pipes 61 to 64 is the same as the preferred range of the outer diameter D1 on the one end 21 side of the gas storage path 2, the outer diameter D2 on the other end 22 side of the gas storage path 2, or the outer diameter D3 of the gas-guiding path 3 in the intermittent-bubbling device 1 in FIG. 1.

Preferably, the outer diameter of each of the first to third joint pipes 66 to 68 is substantially the same as the inner diameter of each of the first to fourth L-shaped pipes 61 to 64 so as to suitably connect the first to fourth L-shaped pipes 61 to 64 to one another.

The cylindrical body 60 forms the gas storage path 2. The cylindrical body 60 is connected to one end 61 A of the first L-shaped pipe 61 with the joint cap 65 therebetween. The joint cap 65 includes a cap portion 65A and a joint portion 65B. The cap portion 65A is fitted on an upper end portion of the cylindrical body 60. The joint portion 65B is fitted in the one end 61 A of the first L-shaped pipe 61 that forms the gas storage path 2. The joint portion 65B is provided on a central portion of the cap portion 65A and is formed to be hollow. The first L-shaped pipe 61 is connected to the cylindrical body 60 in this manner, and thus the first L-shaped pipe 61 defines a path extending from the cylindrical body 60 upward in a substantially vertical direction and a path continuous to this path and extending in a substantially horizontal direction, and forms a part of the gas storage path 2.

The other end 61B of the first L-shaped pipe 61 is connected to one end 62A of the second L-shaped pipe 62 with the first joint pipe 66 therebetween. The second L-shaped pipe 62 is connected to the first L-shaped pipe 61 in this manner, and thus the second L-shaped pipe 62 defines a path extending from the first L-shaped pipe 61 in a substantially horizontal direction and a path continuous to this path and extending downward in a substantially vertical direction, and forms a part of the gas storage path 2.

The other end 62B of the second L-shaped pipe 62 is connected to one end 63A of the third L-shaped pipe 63 with the second joint pipe 67 therebetween. The third L-shaped pipe 63 is connected to the second L-shaped pipe 61 in this manner, and thus the third L-shaped pipe 63 defines a path extending from the second L-shaped pipe 62 downward in a substantially vertical direction and a path continuous to this path and extending in a substantially horizontal direction, and forms a part of the gas storage path 2 and a part of the gas-guiding path 3.

The other end 63B of the third L-shaped pipe 63 is connected to one end 64A of the fourth L-shaped pipe 64 with the third joint pipe 68 therebetween. The fourth L-shaped pipe 64 is connected to the third L-shaped pipe 63 in this manner, and thus the fourth L-shaped pipe 64 defines a path extending from the third L-shaped pipe 63 in a substantially horizontal direction and a path continuous to this path and extending upward in a substantially vertical direction, and forms a part of the gas-guiding path 3. The other end 64B of the fourth L-shaped pipe 64 has an opening. This opening forms a gas discharge port 31.

The third L-shaped pipe 63 may be rotatably connected to the second L-shaped pipe 62. When the third L-shaped pipe 63 is rotatably provided in this manner, the third L-shaped pipe 63 and the fourth L-shaped pipe 64 can be integrally rotated with respect to the second L-shaped pipe 62. That is, the whole of the gas-guiding path 3 and a part of the gas storage path 2 are made rotatable together. When the gas-guiding path 3 is rotatably provided in this manner, the intermittent-bubbling device can be flexibly used for various filtration modules etc. having different shapes, arrangements, and the like of a part into which a gas is introduced.

The intermittent-bubbling device 6 has an overall structure similar to the intermittent-bubbling device 1 in FIG. 1. Therefore, the same advantages as those of the intermittent-bubbling device 1 are achieved. In addition, the intermittent-bubbling device 6 can be formed by connecting a plurality of pipe materials to one another and thus can be produced simply and advantageously in terms of cost.

### Third Embodiment

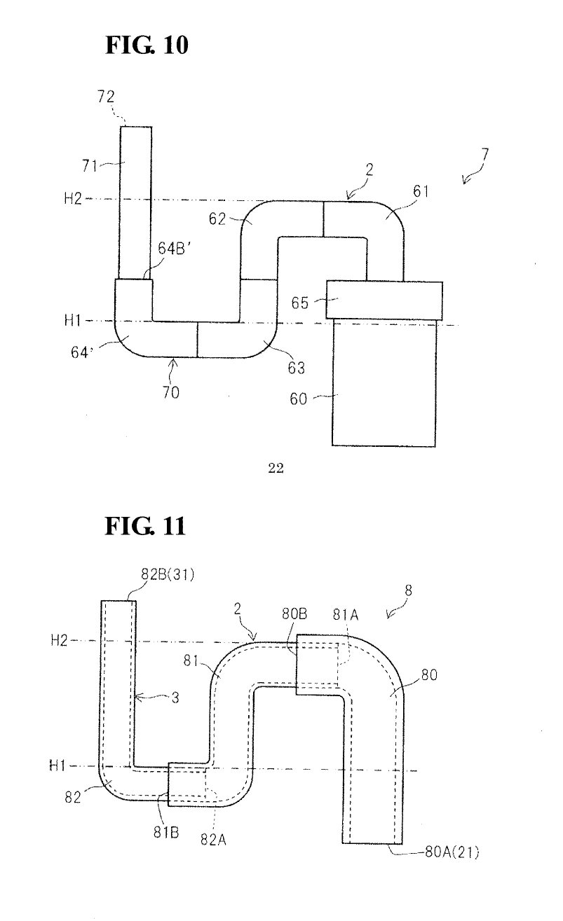

Next, an intermittent-bubbling device according to a third embodiment of the present invention will be described with reference to FIG. 10. In FIG. 10, structures the same as those of the intermittent-bubbling device 6 in FIGS. 7 to 9 are assigned the same reference numerals, and an overlapping description is omitted below.

An intermittent-bubbling device 7 in FIG. 10 is basically the same as the intermittent-bubbling device 6 in FIGS. 7 to 9 but differs in the structure of a gas-guiding path 70.

In the gas-guiding path 70, a straight pipe 71 is fitted in the other end 64W of a fourth L-shaped pipe 64′ to form the other end 72 side. The other end 72 of the gas-guiding path 70 forms a gas discharge port 72. The position of this gas discharge port 72 is higher than a horizontal level position H2, which is a highest point of the gas storage path 2.

According to the intermittent-bubbling device 7, the other end 72 side of the gas-guiding path 70 is formed by fitting the straight pipe 71 in the fourth L-shaped pipe 64. Accordingly, the outer diameter of the gas discharge port 72 is smaller than the outer diameter of the gas storage path 2. Therefore, it becomes easy to increase the differential pressure acting between the front-end interface 40 and the rear-end interface 41 (refer to FIGS. 3 and 4) of the gas 4 in the gas storage path 2.

### Fourth Embodiment

Next, an intermittent-bubbling device according to a fourth embodiment of the present invention will be described with reference to FIG. 11. In FIG. 11, structures the same as those of the intermittent-bubbling device 6 in FIGS. 7 to 9 are assigned the same reference numerals, and an overlapping description is omitted below.

An intermittent-bubbling device 8 in FIG. 11 is basically the same as the intermittent-bubbling device 6 in FIGS. 7 to 9 but differs in that the intermittent-bubbling device 8 is formed by using three pipes.

The intermittent-bubbling device 8 is formed by connecting an L-shaped large-diameter pipe 80, an S-shaped medium-diameter pipe 81, and an L-shaped small-diameter pipe 82 to one another.

Regarding the L-shaped large-diameter pipe 80, one end 80A forms an inlet port 21, and the other end 80B is fitted on one end 81A side of the S-shaped medium-diameter pipe 81. With this structure, the inlet port 21 and the inside of the L-shaped large-diameter pipe 80 communicate with the inside of the S-shaped medium-diameter pipe 81.

Regarding the S-shaped medium-diameter pipe 81, the one end 81A side is fitted in the other end 80B of the L-shaped large-diameter pipe 80, and the other end 81B is fitted on one end 82A side of the L-shaped small-diameter pipe 82. With this structure, the inside of the S-shaped medium-diameter pipe 81 communicates with the inside of the L-shaped large-diameter pipe 80 and the inside of the L-shaped small-diameter pipe 82.

Regarding the L-shaped small-diameter pipe 82, the one end 82A side is fitted in the other end 81B of the S-shaped medium-diameter pipe 81, and the other end 82B forms a gas discharge port 31. With this structure, the inside of the L-shaped small-diameter pipe 82 and the gas discharge port 31 communicate with the inside of the S-shaped medium-diameter pipe 81 and communicate with the inside of the L-shaped large-diameter pipe 80 and the inlet port 21.

In the intermittent-bubbling device 8, the inlet port 21, the inside of the L-shaped large-diameter pipe 80, the inside of the S-shaped medium-diameter pipe 81, the inside of the L-shaped small-diameter pipe 82, and the gas discharge port 31 communicate in series. In addition, the outer diameter (cross-sectional area) of a tube path extending from the inlet port 21 to the gas discharge port 31 gradually decreases. Therefore, the diameter (cross-sectional area) of the gas discharge port 31 is smaller than the outer diameter (cross-sectional area) of the inlet port 21. As a result, a suitable differential pressure can be applied between the front-end interface 40 and the rear-end interface 41 (refer to FIGS. 3 and 4) of the gas 4 in the gas storage path 2. Furthermore, the intermittent-bubbling device 8 has a structure obtained by connecting the three pipes 80, 81, and 82 and thus can be easily formed.

### Fifth Embodiment

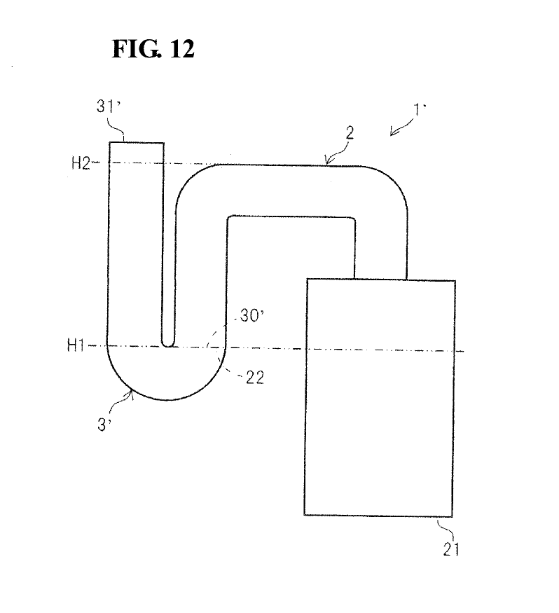

Next, an intermittent-bubbling device according to a fifth embodiment of the present invention will be described with reference to FIG. 12. In FIG. 12, structures the same as those of the intermittent-bubbling device 1 in FIG. 1 are assigned the same reference numerals, and an overlapping description is omitted below.

An intermittent-bubbling device 1′ in FIG. 12 is basically the same as the intermittent-bubbling device 1 in FIG. 1 but differs in the structure of a gas-guiding path 3′.

The gas-guiding path 3′ is disposed adjacent to the other end 22 side of a gas storage path 2. That is, the other end 22 side of the gas storage path 2 and the gas-guiding path 3′ form a hairpin shape, and a horizontal portion on one end 30′ side of the gas-guiding path 3′ is not substantially present. The horizontal level position of the other end (gas discharge port) 31′ of the gas-guiding path 3′ is higher than a horizontal level position H2, which is a highest point of the gas storage path 2. The outer diameter (cross-sectional area) of the gas discharge port 31′ is smaller than the outer diameter (cross-sectional area) of the inlet port 21.

According to the intermittent-bubbling device 1′, the gas 4 can be guided to the gas-guiding path 3′ without substantially moving gas in the gas storage path 2 in the horizontal direction. Accordingly, the effect of releasing the gas stored in the gas storage path 2 at one time is more effectively achieved.

### Sixth Embodiment

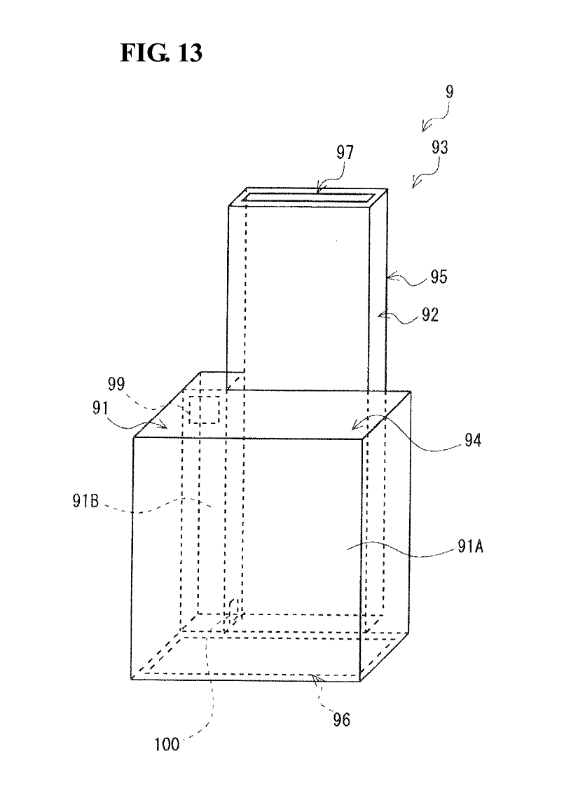

Next, an intermittent-bubbling device according to a sixth embodiment of the present invention will be described with reference to FIGS. 13 to 16.

An intermittent-bubbling device 9 in FIG. 13 includes a gas storage path 91 and a gas-guiding path 92. The intermittent-bubbling device 9 includes a box body 93 and a plurality of partition walls 98A and 98B that partition the inside of the box body 93. The gas storage path 91 and the gas-guiding path 92 are formed by dividing a single box body 93 into sections and allowing the sections to communicate with each other.

### <Box Body>

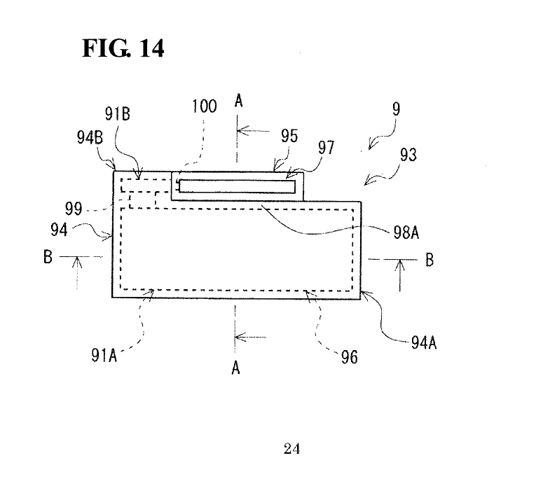

The box body 93 includes a gas storage path-forming portion 94 having an L-shape in plan view and a gas-guiding-path-forming portion 95 having a rectangular shape in plan view. As illustrated in FIG. 14, the gas storage path-forming portion 94 includes a main portion 94A and an auxiliary portion 94B. The main portion 94A has a rectangular shape in plan view in which a left-right direction is defined as a longitudinal direction. The auxiliary portion 94B protrudes backward from one end side (the left end side in FIG. 14) of the main portion 94A in the longitudinal direction and has a rectangular shape in plan view in which the left-right direction is defined as the longitudinal direction. The length of the main portion 94A in a short direction (the length in a front-back direction) is larger than the length of the auxiliary portion 94B in the short direction (the length in the front-back direction). Regarding the gas-guiding-path-forming portion 95, the left-right direction is defined as a longitudinal direction in plan view. One end (the left end in FIG. 14) of the gas-guiding-path-forming portion 95 in the longitudinal direction is connected to the other end (the right end in FIG. 14) of the auxiliary portion 94B in the longitudinal direction. The other end (front end) of the gas-guiding-path-forming portion 95 in the short direction is connected to one end (back end) of the main portion 94A in the short direction. Note that the terms “front”, “back”, “left”, and “right” are determined for the sake of convenience in which the main portion 94A side is defined as the front, and the gas-guiding-path-forming portion 95 side is defined as the back in accordance with FIG. 13, and do not specifically define the structure of the box body 93.

The length of the auxiliary portion 94B in the short direction (the length in the front-back direction) is the same as the length of the gas-guiding-path-forming portion 95 in the short direction (the length in the front-back direction). The gas-guiding-path-forming portion 95 is disposed at the center of the box body 93 in the left-right direction. The length of the gas-guiding-path-forming portion 95 in the longitudinal direction (the length in the left-right direction) is larger than the length of the auxiliary portion 94B in the longitudinal direction (the length in the left-right direction), and the total of these lengths is shorter than the length of the main portion 94A in the longitudinal direction (the length in the left-right direction). Accordingly, the box body 93 is formed to have a substantially rectangular shape in plan view in which a back portion on the other end (the right end in FIG. 14) of the main portion 94A in the longitudinal direction is cut out.

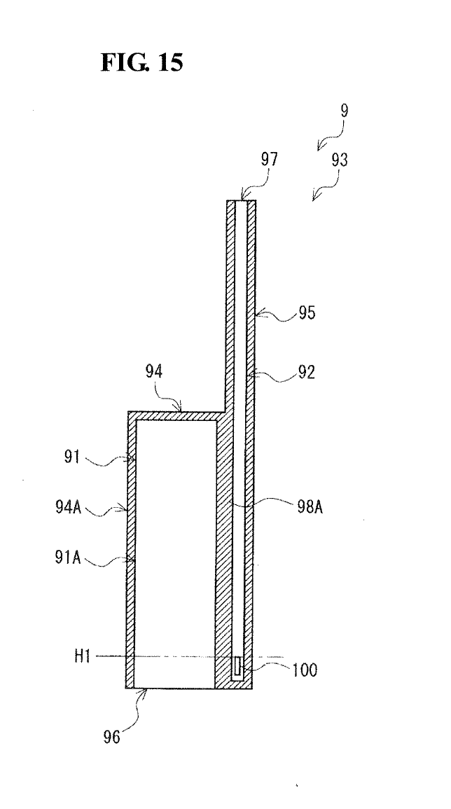

As illustrated in FIG. 15, the gas storage path-forming portion 94 and the gas-guiding-path-forming portion 95 are formed so that the lower ends thereof are flush with each other. The upper end of the gas-guiding-path-forming portion 95 is higher than the upper end of the gas storage path-forming portion 94. The inside of the box body 93 is hollow. Openings 96 and 97 are formed in the lower end of the main portion 94A and in the upper end of the gas-guiding-path-forming portion 95, respectively.

### <Partition Walls>

As illustrated in FIG. 15, a first partition wall 98A defines an inner space of the main portion 94A and inner spaces of the auxiliary portion 94B and the gas-guiding-path-forming portion 95. The first partition wall 98A has a rectangular opening 99 in an upper portion of a region that defines the inner spaces of the main portion 94A and the auxiliary portion 94B.

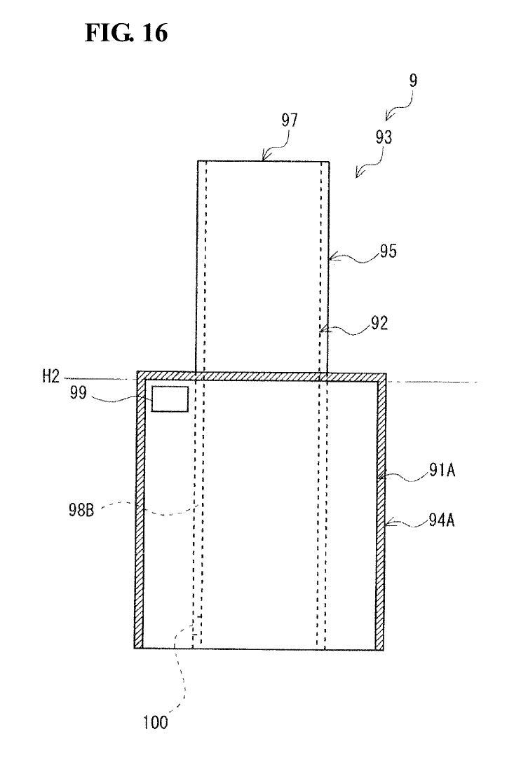

As illustrated in FIG. 16, a second partition wall 98B defines the inner space of the auxiliary portion 94B and the inner space of the gas-guiding-path-forming portion 95. The second partition wall 98B has a rectangular opening 100 in a lower portion thereof.

### <Gas Storage Path>

One end 91 A side of the gas storage path 91 has a rectangular parallelepiped shape formed by the main portion 94A and the first partition wall 98A. The one end 91 A side of the gas storage path 91 opens downward to form an inlet port. The other end 91B side of the gas storage path 91 has a rectangular parallelepiped shape formed by the auxiliary portion 94B, the first partition wall 98A, and the second partition wall 98B. The one end 91A side of the gas storage path 91 and the other end 91B side of the gas storage path 91 are allowed to communicate with each other through the opening 99 formed in the first partition wall 98A to thereby form a substantially inverted U-shape.

### <Gas-Guiding Path>

The gas-guiding path 92 has a rectangular parallelepiped shape formed by the gas-guiding-path-forming portion 95, the first partition wall 98A, and the second partition wall 98B. The gas-guiding path 92 opens upward to form a gas discharge port. The gas storage path 92 is allowed to communicate with the other end 91 B side of the gas storage path 91 through the opening 100 formed in the second partition wall 98B.

As described above, since the upper end of the gas-guiding-path-forming portion 95 is higher than the upper end of the gas storage path 94, as illustrated in FIG. 16, the upper end of the gas-guiding path 92 is located higher than a horizontal level position H2, which is a highest point of the gas storage path 91. That is, the upper end of the gas-guiding path 92 is located at a level equal to or higher than the highest point of the gas storage path 91.

The highest point at the lowest position of the gas-guiding path 92, the highest point being defined by the upper side of the opening 100, is located so as not to be lower than the other end of the gas storage path 91.

As described above, the length of the main portion 94A in the short direction is larger than the length of the gas-guiding-path-forming portion 95 in the short direction, and, the length of the main portion 94A in the longitudinal direction is larger than the length of the gas-guiding-path-forming portion 95 in the longitudinal direction. Therefore, as illustrated in FIG. 15, the cross-sectional area on the one end 91A side of the gas storage path 91 at a horizontal level position H1 horizontal to the other end of the gas storage path 91 is larger than the cross-sectional area of the gas-guiding path 92.

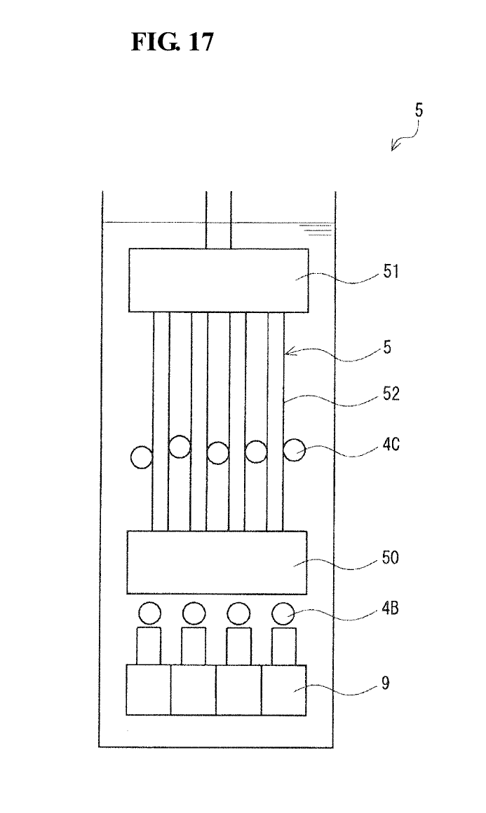

The intermittent-bubbling device 9 has an overall structure similar to the intermittent-bubbling device 1 in FIG. 1. Therefore, the same advantages as those of the intermittent-bubbling device 1 are achieved. Furthermore, the intermittent-bubbling device 9 includes the gas storage path 91 and the gas-guiding path 92 that are formed by dividing a single box body 93 into sections and allowing the sections to communicate with each other. Thus, the gas storage path 91 and the gas-guiding path 92 can be easily formed. According to this structure, for example, as illustrated in FIG. 17, a plurality of the intermittent-bubbling devices 9 can be easily arranged in series by allowing sidewalls (left and right sidewalls of the gas storage path-forming portion 94) to face each other. Furthermore, a plurality of bubbles can be released at a high density.

### Seventh Embodiment

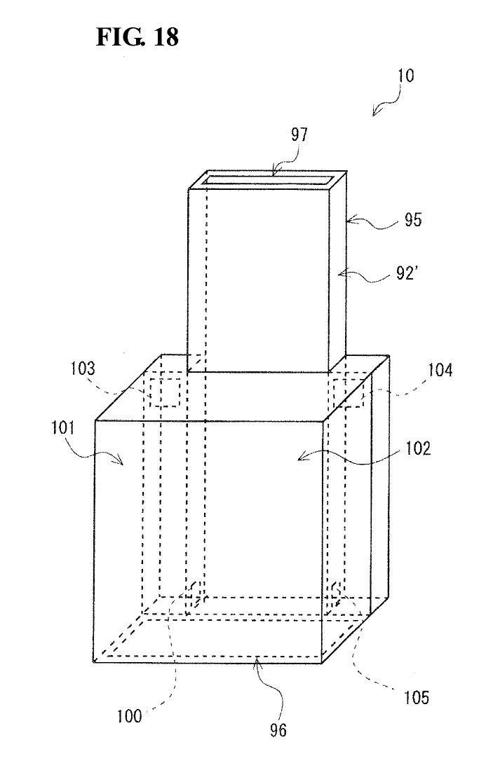

Next, an intermittent-bubbling device according to a seventh embodiment of the present invention will be described with reference to FIGS. 18 to 20. In FIGS. 18 to 20, structures the same as those of the intermittent-bubbling device 9 in FIGS. 13 to 16 are assigned the same reference numerals, and an overlapping description is omitted below.

An intermittent-bubbling device 10 in FIGS. 18 to 20 is basically the same as the intermittent-bubbling device 9 in FIGS. 13 to 16. However, the intermittent-bubbling device 10 differs in the structures of a gas storage path-forming portion 102 and a first partition wall 98A′ and in that the intermittent-bubbling device 10 includes a third partition wall 98C. Accordingly, the intermittent-bubbling device 10 has a structure in which the other end side 101B and 101C of a gas storage path 101 is divided into two sections.

### <Gas Storage Path-Forming Portion>

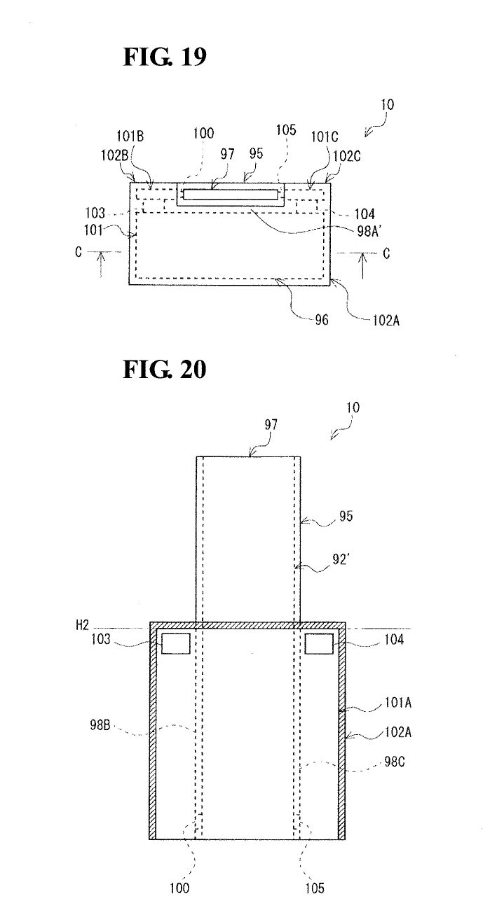

As illustrated in FIG. 19, a gas storage path-forming portion 102 includes a main portion 102A, a first auxiliary portion 102B, and a second auxiliary portion 102C. The main portion 102A has a rectangular shape in plan view in which a left-right direction is defined as a longitudinal direction. The first auxiliary portion 102B protrudes backward from one end side (the left end side in FIG. 19) of the main portion 102A in the longitudinal direction and has a rectangular shape in plan view in which the left-right direction is defined as the longitudinal direction. The second auxiliary portion 102C protrudes backward from the other end (the right end side in FIG. 19) of the main portion 102A in the longitudinal direction and has a rectangular shape in plan view in which the left-right direction is defined as the longitudinal direction. The main portion 102A and the first auxiliary portion 102B of the gas storage path-forming portion 102 respectively have the same structures as the main portion 94A and the auxiliary portion 94B of the gas storage path-forming portion 94 in FIG. 14.

The second auxiliary portion 102C is formed to have a shape symmetrical with the first auxiliary portion 102B in the left-right direction in the front view of the intermittent-bubbling device 10. The second auxiliary portion 102C is disposed at a position symmetric with the first auxiliary portion 102B in the left-right direction in the front view of the intermittent-bubbling device 10. Accordingly, the intermittent-bubbling device 10 is formed to have a rectangular shape in plan view.

### <Partition Walls>

The first partition wall 98A′ is used instead of the first partition wall 98A in FIG. 14. As illustrated in FIG. 19, the first partition wall 98A′ defines an inner space of the main portion 102A and inner spaces of the first auxiliary portion 102B and the second auxiliary portion 102C. The first partition wall 98A′ has a rectangular opening 103 in an upper portion of a region that defines the inner spaces of the main portion 102A and the first auxiliary portion 102B. The first partition wall 98N has a rectangular opening 104 in an upper portion of a region that defines the inner spaces of the main portion 102A and the second auxiliary portion 102C. As illustrated in FIG. 20, the openings 103 and 104 are disposed at the same horizontal level position.

The third partition wall 98C defines the inner space of the second auxiliary portion 102C and an inner space of a gas-guiding-path-forming portion 95. The third partition wall 98C has a rectangular opening 105 in a lower portion thereof. As illustrated in FIG. 20, the openings 100 and 105 are disposed at the same horizontal level position.

### <Gas Storage Path>

One end 101 A side of the gas storage path 101 has a rectangular parallelepiped shape formed by the main portion 102A and the first partition wall 98A′. The one end 101A side of the gas storage path 101 opens downward to form an inlet port. The other end side 101B of the gas storage path 101 is divided into two sections. One of the sections has a rectangular parallelepiped shape formed by the first auxiliary portion 102B, the first partition wall 98A′, and the second partition wall 98B. The other has a rectangular parallelepiped shape formed by the second auxiliary portion 102C, the first partition wall 98A′, and the second partition wall 98C. The one end 101A side of the gas storage path 101 and the other end 101 B side are allowed to communicate with each other through each of the openings 103 and 104 formed in the first partition wall 98A′ to thereby form a substantially inverted U-shape.

### <Gas-Guiding Path>

A gas-guiding path 92′ has a rectangular parallelepiped shape formed by the gas-guiding-path-forming portion 95, the first partition wall 98A′, the second partition wall 98B, and the third partition wall 98C. The gas-guiding path 92′ opens upward to form a gas discharge port. The gas storage path 92′ is allowed to communicate with the other end side 101B and the other end side 101C of the gas storage path 101 through the openings 100 and 105 formed in the second partition wall 98B and the third partition wall 98C, respectively.

Since the intermittent-bubbling device 10 has an overall structure similar to the intermittent-bubbling device 9 in FIGS. 13 to 16, the same advantages as those of the intermittent-bubbling device 9 are achieved. Furthermore, according to the intermittent-bubbling device 10, since the other end 101B and 101C side of the gas storage path 101 are divided into a plurality of sections, gas in the gas storage path 101 can be efficiently guided to the gas-guiding path 92′ to increase a releasing efficiency of bubbles.

### Other Embodiments

It is to be understood that the embodiments disclosed herein are only illustrative and are not restrictive in all respects. The scope of the present invention is not limited to the structures of the embodiments but is defined by the claims described below. It is intended that the scope of the present invention includes equivalents of the claims and all modifications within the scope of the claims.

Horizontal cross-sectional shapes of a part of or the whole of the gas storage path 2 and the gas-guiding path 3 are not limited to circles but may be polygons, such as rectangles, or other shapes. When the cross sections of the gas storage path 2 and the gas-guiding path 3 have shapes other than circular shapes, the outer diameter of each of the cross sections is, for example, a diameter (equivalent circle diameter) of a perfect circle having the same area as the cross section.

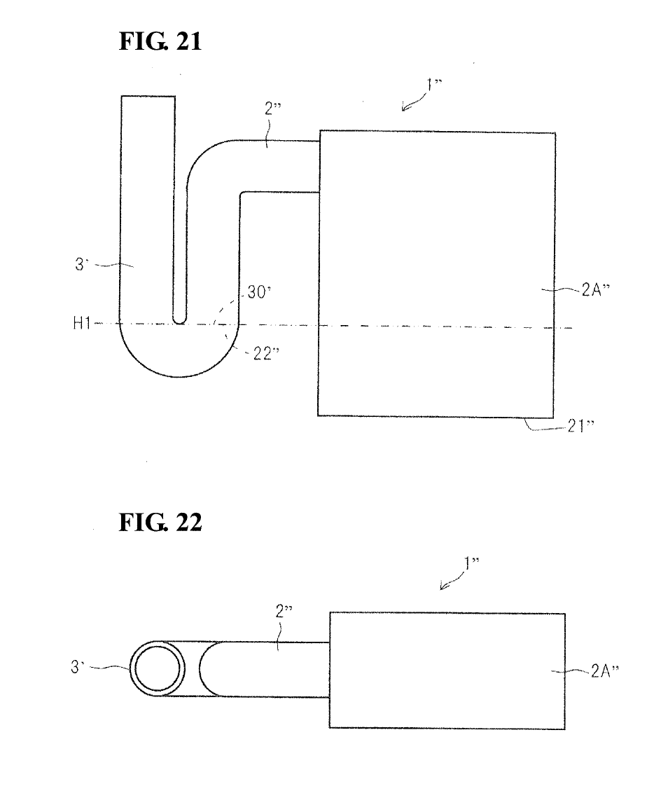

FIGS. 21 and 22 illustrate an intermittent-bubbling device 1″ including a gas storage path 2″, a part of which has a long, rectangular horizontal cross-sectional shape. In this intermittent-bubbling device 1″, one end 21″ side of the gas storage path 2″ is formed from a rectangular parallelepiped box body (having a long, rectangular horizontal cross section) 2A″. On the other hand, the other end 22″ side of the gas storage path 2″ is formed from a pipe. The other end 22″ of the gas storage path 2″ communicates with one end 30′ of a gas-guiding path 3′ similar to that of the intermittent-bubbling device 1′ in FIG. 12.

In the intermittent-bubbling device 1 of the first embodiment, a description has been made of a case where all of or substantially all of the gas 4 in the gas storage path 2 is generated as the bubble 4B. Alternatively, an intermittent-bubbling device may have a structure in which a gas in the gas storage path is not discharged at one time (after a bubble is generated, part of the gas remains in the gas storage path). An example of such a structure is one in which the position of the other end of the gas-guiding path is disposed lower than the highest position of the gas storage path. Alternatively, the intermittent-bubbling device may have a structure other than the structure in which the position of the other end of the gas-guiding path is disposed lower than the highest position of the gas storage path as long as the gas in the gas storage path is not discharged at one time. Alternatively, the intermittent-bubbling device may have a structure in which the gas in the gas storage path is not discharged at one time while the position of the other end of the gas-guiding path is disposed higher than the highest position of the gas storage path.

The joints for connecting the respective L-shaped pipes in the intermittent-bubbling device 6 of the second embodiment and the intermittent-bubbling device 7 of the third embodiment may not be necessarily components that are fitted in L-shaped pipes, but may be components that are fitted on adjacent L-shaped pipes to connect the L-shaped pipes to each other. Furthermore, the joints may be omitted, and L-shaped pipes may be connected to each other by fitting one of the L-shaped pipes to the other L-shaped pipe as in the intermittent-bubbling device 8 illustrated in FIG. 11.

The gas storage path and the gas-guiding path need not be formed by connecting L-shaped pipes to one another but may be formed by connecting pipes having other shapes to one another. The gas storage path and the gas-guiding path may be formed by using, for example, pipes bending at an angle other than 90 degrees.

Furthermore, the directions, the positions, etc. of the gas discharge port and the inlet port are also not limited to the examples illustrated in the drawings but may be variously changed. For example, the gas discharge port may be disposed at the same level as the highest position of the gas storage path.

Regarding the intermittent-bubbling device 9 of the sixth embodiment and the intermittent-bubbling device 10 of the seventh embodiment, the shape of the box body is not particularly limited. For example, a main portion and an auxiliary portion of a gas storage path-forming portion, and a gas-guiding-path-forming portion may be arranged in that order in the left-right direction. The arrangement positions of the partition walls may be appropriately changed in accordance with the arrangement of the main portion and the auxiliary portion of the gas storage path-forming portion, and the gas-guiding-path-forming portion.

Regarding the intermittent-bubbling device 10 of the seventh embodiment, the other end side of the gas storage path may not be necessarily divided into two sections, and may be divided into three or more sections.

Even when an intermittent-bubbling device is formed as a single box body as a whole as in the intermittent-bubbling device 9 of the sixth embodiment and the intermittent-bubbling device 10 of the seventh embodiment, the gas storage path and the gas-guiding path may not be necessarily defined by partition walls. The gas storage path and the gas-guiding path of the intermittent-bubbling device may be formed from, for example, box bodies and formed by connecting the box bodies to one another.

The gas may not be necessarily supplied to the gas storage path in the form of independent bubbles. Alternatively, the gas may be supplied in the form of a non-independent continuous flow. Furthermore, the gas may not be necessarily supplied from a lower side to the gas storage path. Alternatively, the gas may be supplied from, for example, an upper side or a lateral side. A gas inlet port and a liquid suction port may be individually provided. For example, while the inlet port of the embodiments illustrated in the drawings is used as a liquid suction port, a gas inlet port may be provided at another position in the gas storage path.

### INDUSTRIAL APPLICABILITY

The intermittent-bubbling device of the present invention can generate a bubble having a large diameter (volume), and can be suitably used for, for example, cleaning a membrane module.

### REFERENCE SIGNS LIST

1, 1′, 1″ intermittent-bubbling device

2, 2″ gas storage path

2A large-diameter tube

2A″ box body

2B small-diameter tube

2Ba, 2Bb curved portion

20 central portion

21, 21″ one end (inlet port)

22, 22″ other end

3, 3′ gas-guiding path

30, 30′ one end

31, 31′ other end (gas discharge port)

4 gas

4A gas

4B, 4C bubble

40 front-end interface

41 rear-end interface

5 filtration module

50, 51 securing members

52 filtration membrane

6 intermittent-bubbling device

60 cylindrical body

61 to 64 first to fourth L-shaped pipes

61A to 64A one end

61B to 64B other end

64′ fourth L-shaped pipe

64B′ other end

65 joint cap

65A cap portion

65B joint portion

66 to 68 first to third joint pipes

7 intermittent-bubbling device

70 gas-guiding path

71 straight pipe

72 gas discharge port

8 intermittent-bubbling device

80 L-shaped large-diameter pipe

80A one end

80B other end

81 S-shaped medium-diameter pipe

81A one end

81B other end

82 L-shaped small-diameter pipe

82A one end

82B other end

9 intermittent-bubbling device

91 gas storage path

91A one end

91B other end

92, 92′ gas-guiding path

93 box body

94 gas storage path-forming portion

94A main portion

94B auxiliary portion

95 gas-guiding-path-forming portion

96, 97 opening

98A, 98A′ first partition wall

98B second partition wall

98C third partition wall

99, 100 opening

10 intermittent-bubbling device

101 gas storage path

101A one end

101B, 101C other end

102 gas storage path-forming portion

102A main portion

102B first auxiliary portion

102C second auxiliary portion

103, 104, 105 opening

D1 average inner diameter of large-diameter tube 2A (outer diameter on one end side of gas storage path)

D2 average inner diameter of small-diameter tube 2A (outer diameter of central portion and on the other end side of gas storage path)

D3 average outer diameter of gas-guiding path 3

H1 to H4 horizontal level

L liquid

1. An intermittent-bubbling device used while being immersed in a liquid, and
formed from a series of tubes,
the intermittent-bubbling device comprising:
a gas storage path, one end of which opens downward, which stores a predetermined amount of gas, and which has a substantially inverted U-shape; and
a gas-guiding path that communicates with the other end of the gas storage path, and that guides the gas upward from the other end.

2. The intermittent-bubbling device according to claim 1, wherein a highest point at a lowest position of the gas-guiding path is not lower than the other end of the gas storage path.

3. The intermittent-bubbling device according to claim 1, wherein a cross-sectional area on the one end side of the gas storage path at a horizontal level position horizontal to the other end of the gas storage path is larger than a cross-sectional area of the gas-guiding path.

4. The intermittent-bubbling device according to claim 1, wherein an upper end of the gas-guiding path is located at a level equal to or higher than a highest point of the gas storage path.

5. The intermittent-bubbling device according to claim 1, wherein the tubes that form the gas storage path or the gas-guiding path are connected to one another so as to be rotatable about an axis.

6. The intermittent-bubbling device according to claim 1,
wherein the one end side of the gas storage path is formed from a rectangular parallelepiped box body, and
the other end side of the gas storage path is formed from a pipe communicating with the box body.

7. The intermittent-bubbling device according to claim 1, wherein the gas storage path and the gas-guiding path are formed by dividing a single box body into sections and allowing the sections to communicate with each other.

8. The intermittent-bubbling device according to claim 7, wherein the other end side of the gas storage path is divided into a plurality of sections.

9. The intermittent-bubbling device according to claim 1, wherein the intermittent-bubbling device is used for cleaning a filtration module including a filtration membrane.
